(19) United States
(12) Patent Application Publication
(10) Pub. No.: US 2014/0159451 A1
(43) Pub. Date: Jun. 12, 2014

(54) VEHICLE SEAT ASSEMBLY AND METHOD

(71) Applicant: LEAR CORPORATION, Southfield, MI (US)

(72) Inventors: Anthony James MOLLICA, Royal Oak, MI (US); Mark A. FARQUHAR, Ortonville, MI (US); Krzysztof WROBLEWSKI, Washington, MI (US); Long LI, Pudong, Shanghai (CN)

(73) Assignee: LEAR CORPORATION, Southfield, MI (US)

(21) Appl. No.: 14/090,263

(22) Filed: Nov. 26, 2013

Related U.S. Application Data
(60) Provisional application No. 61/733,982, filed on Dec. 6, 2012.

(51) Int. Cl. B60N 2/02

(52) U.S. Cl. CPC B60N 2/0284
USPC 297/284.11

(57) ABSTRACT

A vehicle seat assembly includes a seat cushion arrangement movable between non-extended and extended positions. A seat cushion frame supports a seat cushion and includes a link having a linearly-fixed first end pivotable about an axis of rotation, and a second end rotatable along an arcuate path having a center lying on the axis of rotation. The link is configured such that the second end moves upward for a least a portion of the arcuate path when the seat cushion arrangement is moved between the non-extended and extended positions, and a seat load acts to inhibit upward rotation of the link and maintain the seat cushion arrangement in its then current non-extended or extended position.

### CROSS-REFERENCE TO RELATED APPLICATIONS

This application claims the benefit of U.S. provisional application No. 61/733,982, filed 6 Dec. 2012, which is hereby incorporated herein by reference.

### TECHNICAL FIELD

The present invention relates to a vehicle seat assembly having a multi-position seat cushion arrangement and a method for adjusting such a vehicle seat assembly.

### BACKGROUND

Vehicle seat assemblies are known to have various configurations. Examples of vehicle seat assemblies are described in the following patents and patent applications: U.S. Pat. No. 4,787,674, DE4437539A, and FR2897024A.

### SUMMARY

Embodiments of the invention may include a seat cushion arrangement movable between non-extended and extended positions and including a seat cushion frame supporting the seat cushion. The seat cushion frame includes a link having a linearly-fixed first end that is pivotable about an axis of rotation, and a second end rotatable along an arcuate path having a center lying on the axis of rotation. The link is configured such that the second end moves upward for a least a portion of the arcuate path when the seat cushion arrangement is moved between the non-extended and extended positions, such that a weight of a seat load, such as a seat occupant or a child seat, acts to inhibit upward rotation of the link and maintain the seat cushion arrangement in its then current non-extended or extended position.

Embodiments of the invention may also be configured such that the seat cushion frame includes a slide-bar rotationally fixed and linearly movable between aft and fore positions when the seat cushion arrangement is moved between the non-extended position and the extended position. The link may be disposed toward a front portion of the seat cushion frame and the slide-bar disposed toward a rear portion of the seat cushion frame.

Embodiments of the invention may further include a seat back, and may be configured such that a rear edge of the seat cushion arrangement is disposed at least partially under the seat back when the seat cushion arrangement is in the non-extended position, and such that the rear edge of the seat cushion arrangement is disposed away from the seat back when the seat cushion arrangement is in the extended position. This configuration creates a gap in a fore-aft direction between the rear edge of the seat cushion and the seat back.

Embodiments of the invention may include a vehicle seat assembly that includes a seat cushion arrangement movable between non-extended and extended positions and including a seat cushion frame. The seat cushion frame may include a rear slide-bar and a front rotatable link configured to cooperate with each other such that a front edge of the seat cushion arrangement moves upward as the seat cushion arrangement moves from the non-extended position to the extended position. Even with a movable seat cushion arrangement as described above, in at least some embodiments, the seat cushion arrangement may fold into an upright position, commonly referred to as a “Stadium Position”.

Embodiments of the invention may include a method for adjusting a vehicle seat assembly between a non-extended position and an extended position. The vehicle seat assembly may include a seat cushion arrangement movable between non-extended and extended positions. The method may include the steps of lifting a front portion of the seat cushion arrangement when it is in the non-extended position, and moving the front portion forward while it is lifted such that a rear portion of the seat cushion moves linearly forward. The method may also include the step of moving the front portion downward as it continues to move forward, thereby disposing the seat cushion arrangement in the extended position.

### BRIEF DESCRIPTION OF THE DRAWINGS

FIG. 1 shows a side view of a vehicle seat assembly in accordance with an embodiment of the present invention;

FIG. 2 shows a perspective view of a portion of the vehicle seat assembly shown in FIG. 1; and

FIG. 3 shows a perspective view of the vehicle seat assembly shown in FIG. 2 with a structural side member removed.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

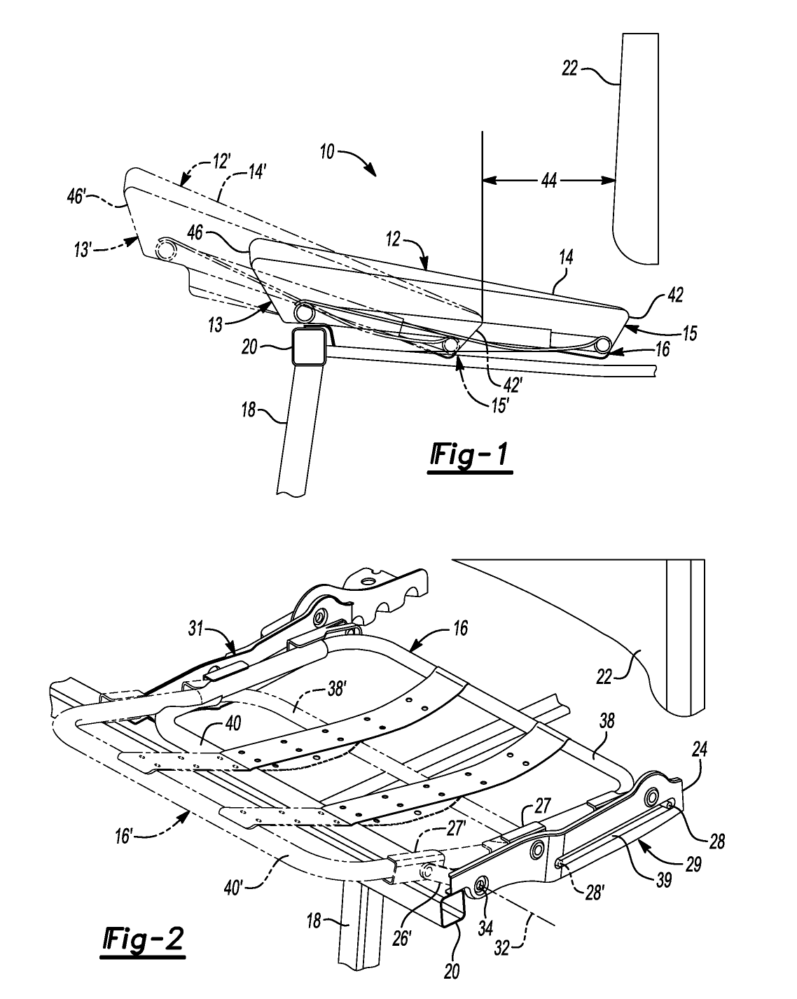

FIG. 1 shows a vehicle seat assembly 10 in accordance with an embodiment of the present invention. The vehicle seat assembly 10 includes a seat cushion arrangement 12 that is movable between a non-extended and an extended position. In the extended position, the seat cushion arrangement 12 is labeled 12′, and all of the components of the vehicle seat assembly 10 are, throughout the drawing figures, labeled with the prime (′) symbol when they are in the extended position. The seat cushion arrangement 12 has a front portion 13 and a rear portion 15, and includes a seat cushion 14 and a seat cushion frame 16. Also shown in FIG. 1 are structural members 18, 20, which may be part of a structural frame of the vehicle seat assembly 10 or, particularly in the case of the square support bar 20, part of a vehicle body. A seat back 22 is also part of the vehicle seat assembly 10 shown in FIG. 1.

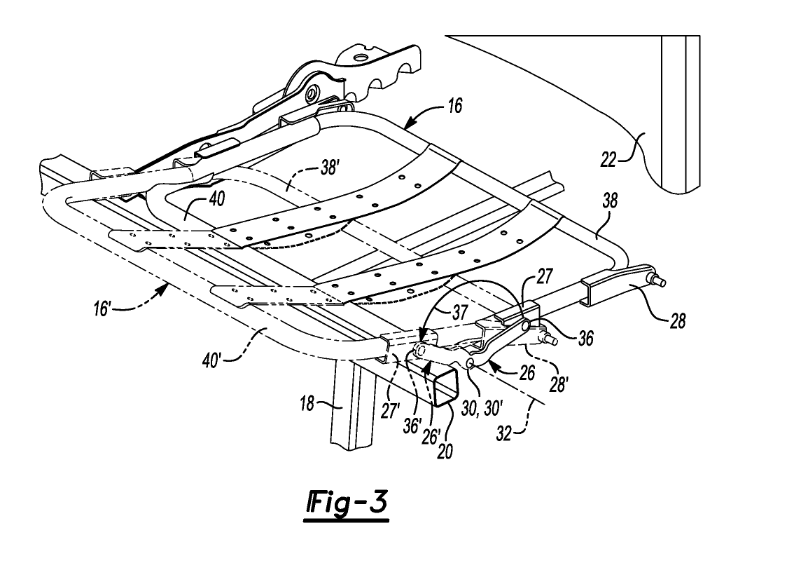

FIG. 2 shows a portion of the seat back 22, and more specifically the seat cushion frame 16 with the seat cushion 14 removed. The seat cushion frame 16 includes a structural side member 24, which works in cooperation with a rotatable link 26—see FIG. 3—and a slide-bar 28 to facilitate movement of the seat cushion arrangement 12 between the non-extended and extended positions. The link 26 is pivotally attached to a connecting member 27. The side member 24, the rotatable link 26, and the slide bar 28 form an extender assembly 29. In the embodiment shown in FIG. 2, the seat cushion frame 16 includes a pair of extender assemblies 29, 31 disposed on opposite sides of the seat cushion frame 16. As seen in more detail in FIG. 3, where the structural side member 24 is removed for clarity, the link 26 has a linearly fixed first end 30, 30′ pivotable about an axis of rotation 32. Specifically, the first end 30, 30′ is fixed to the structural side member 24 at a pivot point 34—see FIG. 2. Therefore, except for its rotation about the axis 32, the first end 30, 30′ is in the same location whether the seat cushion arrangement 12 is in the non-extended or the extended position.

The link 26 also has a second end 36 that is rotatable along an arcuate path indicated by the arrow 37 shown in FIG. 3. As readily seen from the drawing figures, the arcuate path 37 has a center that lies along the axis 32—i.e., the second end 36 of the link 26 travels around a center defined by the pivot point 34. As shown in FIG. 3, the link 26 is configured such that the second end 36 moves upward for at least a portion of the arcuate path 37 when the seat cushion arrangement 12 is moved between the non-extended and extended positions. With this configuration, the weight of a seat load—e.g., the weight of a seat occupant or, for example, a child seat—places a downward force on the second end 36 of the link 26. This inhibits upward rotation of the link 26 and maintains the seat cushion arrangement 12 in its then current position—i.e. in the non-extended or the extended position. Thus, embodiments of the present invention, such as illustrated in FIGS. 1-3, may not include a lock mechanism to keep the seat cushion arrangement in its then current position. In other embodiments, however, a lock mechanism that must be released prior to moving the seat cushion arrangement between the extended and non-extended positions may be included. A structural member, such as the bar 20 or the structural side member 24, can be configured to stop rotation of the link 26 such that it rotates no further than desired.

As described above, the seat cushion frame 16 includes a slide-bar 28 that is rotationally fixed, but is linearly movable between an aft position (28) and a fore position (28′), coinciding with the non-extended and the extended positions, respectively. The slide-bar 28 is constrained by the structural side member 24—see FIG. 2—and specifically, moves linearly within a track 39. The slide-bar 28 is disposed toward a rear portion 38 of the seat cushion frame 16. Conversely, the link 26 is disposed toward a front portion 40 of the seat cushion frame 16. As shown in FIG. 1, a rear edge 42 of the seat cushion 14 is disposed at least partially under the seat back 22 when the seat cushion arrangement 12 is in the non-extended position. When the seat cushion arrangement 12′ is in the extended position, however, the rear edge 42′ is not under the seat back 22, but rather is disposed away and at some distance from the seat back 22, such that a gap 44 in the fore-aft direction is created between the rear edge 42′ of the seat cushion 14′ and the seat back 22.

Although in some embodiments a gap between the seat back and the rear edge of the seat cushion, such as the gap 44 shown in FIG. 1, may be relatively large when the seat is in the extended position, the extended position may nonetheless provide a better configuration for carrying a child seat then would otherwise be available in a seat that did not offer an extended position. Moreover, a seat cushion arrangement can be configured such that a rear edge of a seat cushion, such as the rear edge 42 of the seat cushion 14, extends rearward under the seat back when in the non-extended position, such that when the seat is in the extended position, the rear edge moves forward only until it is proximate the seat back, thereby providing a seat arrangement with little or no gap—where the rear edge is still at least partially under the seat back even when it is in the extended position.

As shown in the drawing figures, and in particular in FIG. 1, a front edge 46 of the seat cushion arrangement 12 is necessarily raised upward as the seat cushion arrangement 12 moves from the non-extended position to the extended position. This is a consequence of the link and slide-bar mechanism and how they cooperate with the structural side member 24—i.e., how the extender assemblies 29, 31 function—as described above. Although a link and slide-bar mechanism is illustrated and described herein, it is understood that different link mechanisms, such as a four-bar link, or a front and rear sliding link, may be used in accordance with embodiments of the present invention.

Embodiments of the present invention may also include a method for adjusting the vehicle seat assembly, such as the seat assembly 10 shown in FIG. 1. The method may include, for example, the steps of lifting a front portion 13 of the seat cushion arrangement 12 when it is in the non-extended position. The front portion 13 is then move forward while it is lifted such that the rear portion 15 of the seat cushion arrangement 12 moves forward along a linear path. As described in detail above, this is a result of the slide-bar mechanism 28 moving within the linear track 39 of the side member 24—although not shown in detail, it is understood that a similar slide-bar and side member track are part of the extender assembly 29 on the other side of the seat cushion arrangement 12 as shown in FIG. 2.

The front portion 13 of the seat cushion arrangement 12 is then moved to downward as it continues to move forward, thereby disposing the seat cushion arrangement 12 and the extended position. As shown in FIGS. 2 and 3, the front portion 13 can be moved to downward until the rotatable link 36 abuts the support member 20, thereby stopping the downward movement. As described above, embodiments of the invention may be configured such that another structural member, for example, the side member 24, is configured to mechanically stop the downward movement of the link 36. Such an arrangement may be particularly desirable when the seat assembly is disposed in the Stadium Position, since a side member can be attached in such a way as to rotate with the rest of the frame 16 into the Stadium Position, and will therefore be available to provide a mechanical stop even in that position. Conversely, some structural members, such as the support member 20, are fixed and therefore may be unavailable as a stop mechanism in the Stadium Position.

As shown in FIG. 3, the upward, forward and downward movements of the front portion 13 of the seat cushion arrangement 12 follow the arcuate path 37. In the embodiment illustrated in FIG. 1, moving the front portion 13 of the seat cushion arrangement 12 forward as described above also moves the rear edge 42 of the seat cushion 14 from a position under the seat back 22 to a position in front of the seat back 22, as shown by the rear edge 42′ in the extended position in FIG. 1.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle seat assembly comprising:
a seat cushion arrangement movable between a non-extended position and an extended position and including a seat cushion frame supporting the seat cushion, the seat cushion frame including a link having a linearly-fixed first end pivotable about an axis of rotation, and a second end rotatable along an arcuate path having a center lying on the axis of rotation, the link being configured such that the second end moves upward for a least a portion of the arcuate path when the seat cushion arrangement is moved between the non-extended and extended positions, such that a seat load acts to inhibit rotation of the link and maintain the seat cushion arrangement in its then current non-extended or extended position.

2. The vehicle seat assembly of claim 1, wherein the seat cushion frame includes a slide-bar rotationally fixed and linearly movable between aft and fore positions when the seat cushion arrangement is moved between the non-extended position and the extended position.

3. The vehicle seat assembly of claim 2, wherein the link is disposed toward a front portion of the seat cushion frame and the slide-bar is disposed toward a rear portion of the seat cushion frame.

4. The vehicle seat assembly of claim 2, further comprising a side member which cooperates with the link and the slide-bar to form an extender assembly, and wherein the seat cushion frame includes a pair of the extender assemblies disposed on opposite sides of the seat cushion frame.

5. The vehicle seat assembly of claim 1, further comprising a seat back, and wherein the seat cushion arrangement further includes a seat cushion, and a rear edge of the seat cushion is disposed at least partially under the seat back when the seat cushion arrangement is in the non-extended position.

6. The vehicle seat assembly of claim 5, wherein the rear edge of the seat cushion is disposed away from the seat back when the seat cushion arrangement is in the extended position such that a gap exists in a fore-aft direction between the rear edge of the seat cushion and the seat back.

7. The vehicle seat assembly of claim 1, wherein the link is disposed within the seat cushion arrangement such that it abuts a support member which stops rotation of the link when the seat arrangement is in the extended position.

8. A vehicle seat assembly comprising:
a seat cushion arrangement movable between a non-extended position and an extended position and including a seat cushion frame having a slide-bar and a rotatable link configured to cooperate with each other such that a front portion of the seat cushion arrangement moves upward as the seat cushion arrangement moves between the non-extended position and the extended position.

9. The vehicle seat assembly of claim 8, wherein the rotatable link includes a linearly-fixed first end pivotable about an axis of rotation, and a second end rotatable along an arcuate path having a center lying on the axis of rotation.

10. The vehicle seat assembly of claim 9, wherein the second end of the rotatable link moves upward for a least a portion of the arcuate path when the seat cushion arrangement is moved between the non-extended and extended positions, thereby effecting the upward movement of the front portion of the seat cushion arrangement.

11. The vehicle seat assembly of claim 9, wherein the rotatable link is disposed within the seat cushion arrangement such that a seat load acts to inhibit rotation of the rotatable link about the axis of rotation and maintain the seat cushion arrangement in its then current non-extended or extended position.

12. The vehicle seat assembly of claim 9, wherein the rotatable link is disposed within the seat cushion arrangement such that it abuts a support member which stops rotation of the link when the seat arrangement is in the extended position.

13. The vehicle seat assembly of claim 8, wherein the slide-bar is rotationally fixed and linearly movable between aft and fore positions when the seat cushion arrangement is moved between the non-extended position and the extended position.

14. The vehicle seat assembly of claim 8, further comprising a seat back, and wherein the seat cushion arrangement further includes a seat cushion, and a rear edge of the seat cushion is disposed at least partially under the seat back when the seat cushion arrangement is in the non-extended position.

15. The vehicle seat assembly of claim 14, wherein the rear edge of the seat cushion is disposed at a distance from the seat back when the seat cushion arrangement is in the extended position such that the rear edge of the seat cushion is not disposed under the seat back.

16. The vehicle seat assembly of claim 8, further comprising a side member which cooperates with the rotatable link and the slide-bar to form an extender assembly, and wherein the seat cushion frame includes a pair of the extender assemblies disposed on opposite sides of the seat cushion frame.

17. A method for adjusting a vehicle seat assembly between a non-extended position and an extended position, the vehicle seat assembly including a seat cushion arrangement movable between non-extended and extended positions, the method comprising:
lifting a front portion of the seat cushion arrangement when it is in the non-extended position;
moving the front portion forward while it is lifted such that a rear portion of the seat cushion arrangement moves linearly forward; and
moving the front portion downward as it continues to move forward, thereby disposing the seat cushion arrangement in the extended position.

18. The method of claim 17, wherein the vehicle seat assembly further includes a seat back, and the seat cushion arrangement includes a seat cushion, and wherein the step of moving the front portion forward includes moving a rear edge of the seat cushion from a position under the seat back to a position in front of the seat back.

19. The method of claim 17, wherein the seat cushion arrangement includes a seat cushion frame, and wherein the step of moving the front portion downward includes moving the front portion downward until a portion of the seat cushion frame abuts a support member, thereby stopping the downward movement.

20. The method of claim 19, further comprising moving a rear portion of the seat cushion frame forward along a linear path while the front portion is lifted and moved forward.
